(19) United States
(12) Patent Application Publication
(10) Pub. No.: US 2004/0129229 A1
(43) Pub. Date: Jul. 8, 2004

(54) Wall hung automated pet feeding machine

(76) Inventors: Michel Blais, St-Jean-sur-Richelieu (CA); Michel Champagne, St-Jean-sur-Richelieu (CA)

Correspondence Address: INVENTARIUM, 4050 Rosemont blvd # 1607, Montreal, QC, H1X 1M4, CA

(21) Appl. No.: 10/435,418

(22) Filed: May 12, 2003

Related U.S. Application Data
(60) Provisional application No. 60/438,388, filed on Jan. 8, 2003.

(51) Int. Cl. A01K 61/02

(52) U.S. Cl. 119/56.1

(57) ABSTRACT

An automated pet feeding machine has a very simple system for measuring and distributing food quantities using the combination of a solenoid, slidable panels and a biasing means to tilt a food measuring tray down from a first position into a second position where its content is poured into a pet's feeding bowl. The downward tilt motion of the food measuring tray blocks any food from flowing out of the hopper during this step.

### BACKGROUND OF THE INVENTION

1. Field of the invention

This invention relates generally to automated machines and more particularly to machines that distribute pet food at preset intervals and in preset quantities.

2. Background

The prior art shows a number of pet food distribution machines, each automated to varying degrees of complexity. Generally, these machines have a large reservoir to contain food and a mechanism, generally in the form of a paddle wheel or in some cases a screw conveyor, that distributes a set quantity of food. A timer also allows for the food to be distributed at preset times. Variations between the different prior art can be found in the different ways by which food quantities are measured. For example, U.S. Pat. No. 5,303,672 by Morris has a rotating wheel having sections that can be blocked to control the amount while U.S. Pat. No. 5,433,171 by Ewell uses weight as a way to measure quantities.

Generally, the distributing machines found in the prior art involve many electrical and mechanical components which makes them bulky, noisy and most of all, rather expensive. That is why they have not found popularity in the marketplace.

There is therefore a need for a practical, efficient, safe and inexpensive automated pet feeding machine.

### SUMMARY OF THE INVENTION

One object of the present invention is to provide a practical pet feeding machine.

A second object of the present invention is to provide an efficient pet feeding machine.

A third object of the present invention is to provide a safe pet feeding machine.

A final object of the present invention is to provide an inexpensive pet feeding machine.

In order to do so, the invention has a very simple system for measuring and distributing food quantities using the combination of a solenoid, slidable panels and a biasing means to tilt a food measuring tray down from a first position into a second position where its content is poured into a pet's feeding bowl. The downward tilt motion of the food measuring tray blocks any food from flowing out of the hopper during this step. Once electrical power is cut off to the solenoid, the biasing means biases the food measuring tray back to its first position where the hopper's exit is liberated and a portion is once again poured into the food measuring tray, ready for the next feed cycle.

In order to keep costs down, not even a timer is included since such timers can be easily found in the marketplace and allows the buyer more choice as to the type of timer. Additionally, additional hopper modules can be purchased separately to increase the size of the hopper.

The foregoing and other objects, features, and advantages of this invention will become more readily apparent from the following detailed description of a preferred embodiment with reference to the accompanying drawings, wherein the preferred embodiment of the invention is shown and described, by way of examples. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE PREFERRED EMBODIMENT

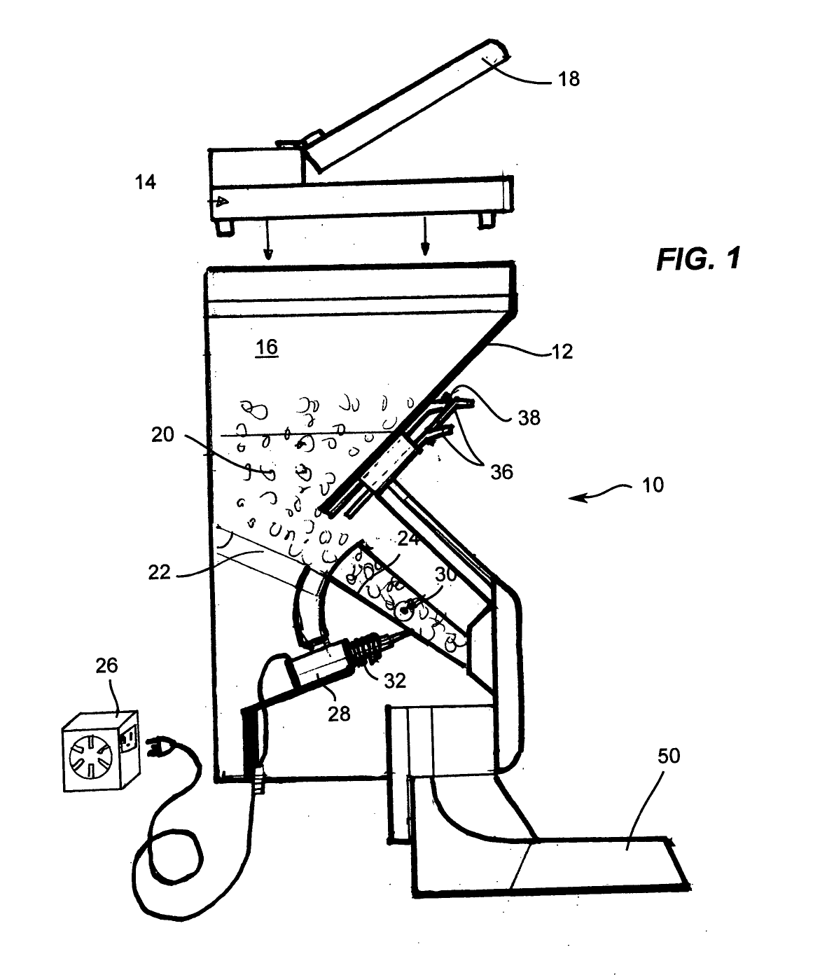

FIG. 1 Side elevation of the automated pet feeding machine set at the first mode.

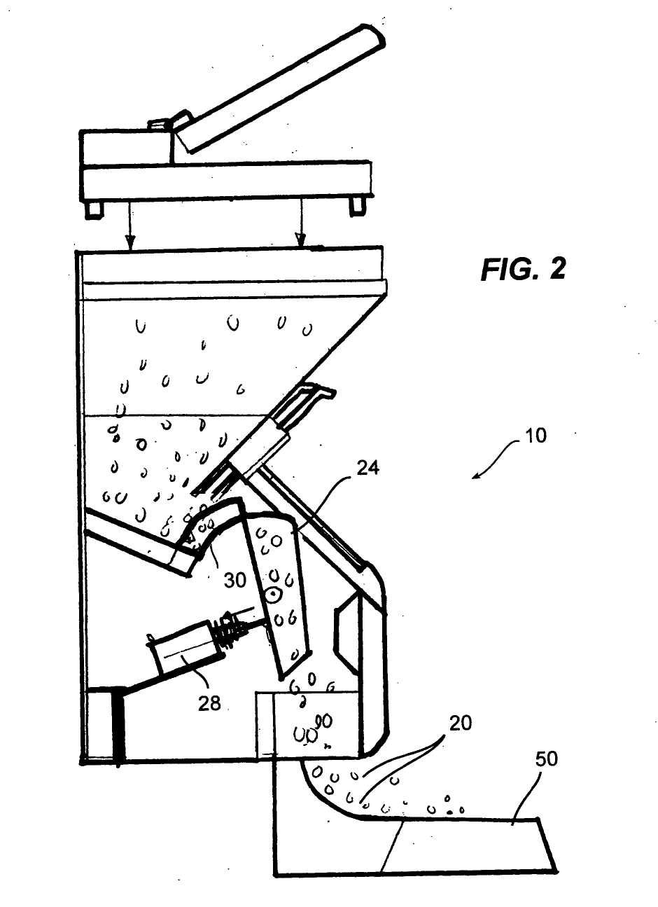

FIG. 2 Side elevation of the automated pet feeding machine set at the second mode.

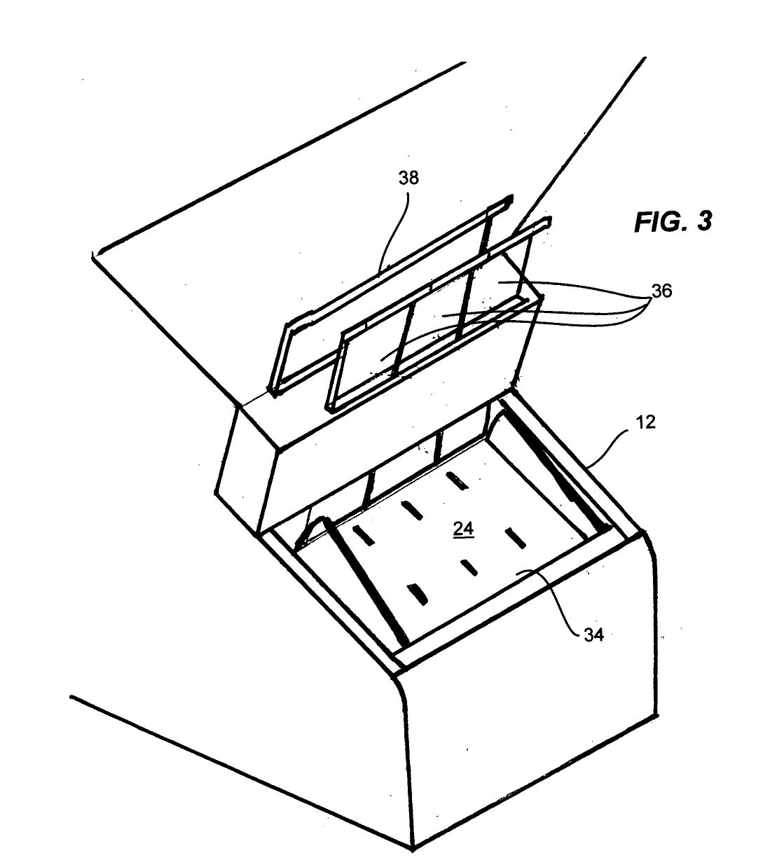

FIG. 3 Orthogonal view of the food tray with its servings vanes.

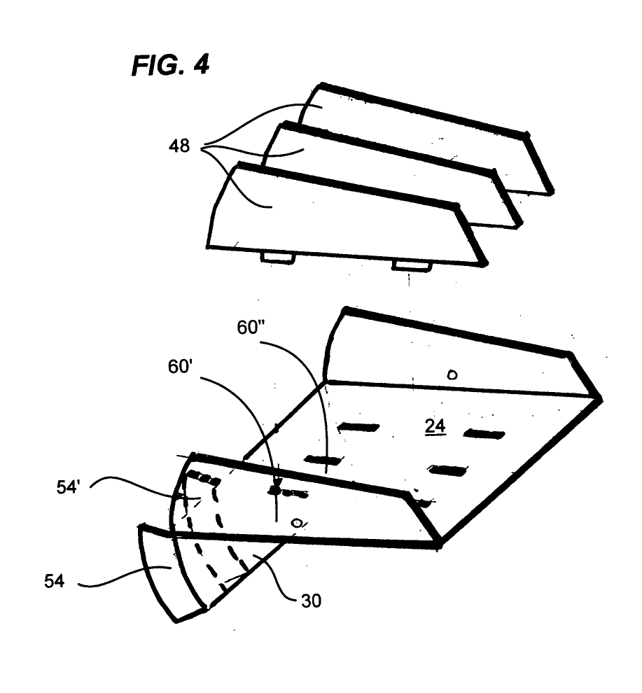

FIG. 4 Orthogonal view of the food tray and its partitions.

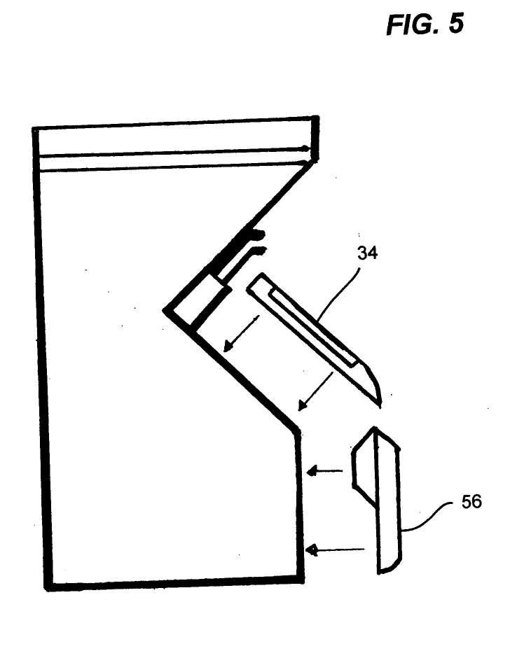

FIG. 5 Side elevation of the the automated pet feeding machine with its front panels taken out.

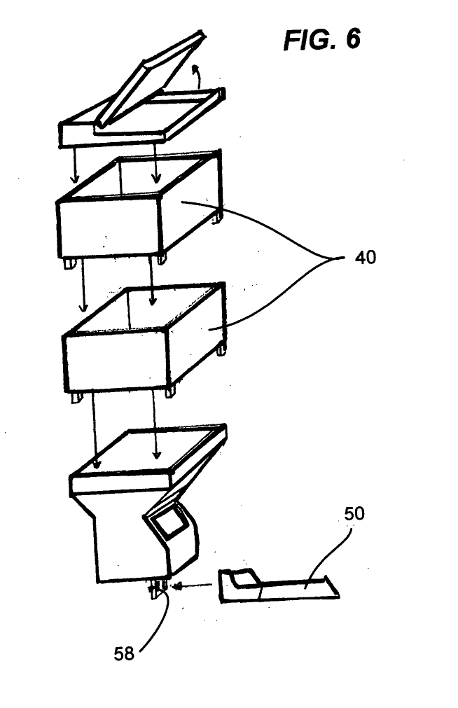

FIG. 6 Orthogonal view of the automated pet feeding machine with its additional hopper modules.

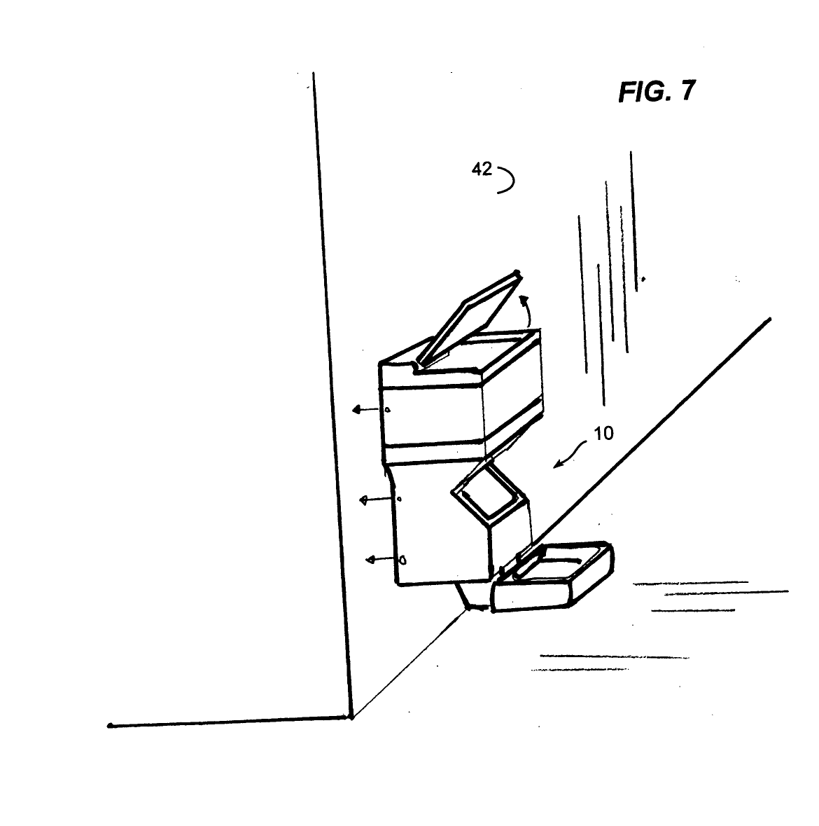

FIG. 7 Orthogonal view of the automated pet feeding machine installed on a wall.

### DETAILED DESCRIPTION OF THE PREFERRED EMBODIMENT

FIG. 1 An automated pet feeding machine (10) has a housing (12), a removable lid assembly (14), a hopper (16), a chute (22) and a food tray (24). By lifting the lid (18) from the removable lid assembly system (14), a user can pour dry pet food (20) into the hopper (16). From there, the chute (22) allows some of the food to spill into the food tray (24) where it will stay until a timer (26), which is not an integral part of the invention but rather a separate accessory, activates a solenoid (28) which tilts the food tray (24) around a rotational axis (30) downward from a first position into a second position where the pet food (20) is poured, via an exit aperture, into a pet feeding bowl (50).

FIG. 2 The downward tilt motion of the food tray (24) blocks any pet food (20) from flowing out of the hopper (16) during this step by way of a chute blocker (30). Once the timer (26) cuts off electrical power to the solenoid (28), a biasing means (32) brings the food tray (24) back to its first position where the chute (22) is once again liberated and a portion of pet food (20) is again poured into the food tray (24), ready for the next feed cycle.

FIG. 3 The housing (12) has a window (34) through which one can see the food tray (24). Entry of food is regulated by slidable vanes (36) which can be slid open one at a time with each vane (36) giving out one portion. A main blocker (38) is slidably adjusted according to the size of the food (20) pellets so that the portions flowing into the compartments are similar. Typically, each compartment holds ½ cup of food (20).

FIG. 4 The food tray (24) is subdivided into a plurality of compartments (60′, 60″) by partitions (48). The food tray (24) also has a chute blocker (30) which stops the food (20) from escaping the hopper (16) while the food tray (24) moves into its second position. There are two fins (54, 54′) extending perpendicularly from the chute blocker (30) that are positioned and configured so as to eliminate possible jamming of food. The first fin (54) is positioned against the housing (12) and in line with the side of the food tray (24) while the second fin (54′) is in line with the partition (48) which separates the first compartment (60′) from the second compartment (60″). When the food tray (24) moves from the first to the second position, the fins (54, 54′) push into the food (20) and actually create an area where the food is less packed which ultimately prevents jamming of the food (20) so that it can easily flow into the food tray (24) afterwards.

FIG. 5 Access to the food tray (24) is made easy through a removable window (34) as well as a removable bottom panel (56) which gives access to the solenoid (28).

FIG. 6 Additional hopper modules (40) can be purchased separately to increase the capacity for food (20) storage. The bowl (50) is releasably attached by releasably attachable means (58) to the rest of the pet feeding machine (10) so that the food (20) can spill into it properly and so that pets can't displace it while being sufficiently releasable for cleaning purposes.

FIG. 7 The automated pet feeding machine (10) is preferably installed on a wall (42) from which it hangs, being held in place through mechanical means passing through holes (44). Each additional hopper modules (40) can also be mechanically fastened to the wall (42).

1. An automated pet feeding machine comprising
a housing, a removable lid assembly, a hopper, a chute a food tray and a bowl;
a solenoid to tilt said food tray around a rotational axis from a first position into a second position and back;
a chute blocker to stop food from escaping said hopper while said food tray is in its second position;
a plurality of slidable vanes to regulate quantitiy of food;
a main blocker slidably adjustable according to the size of the food;
two fins extending perpendicularly from said chute blocker, positioned and configured so as to eliminate possible jamming of food.

2. An automated pet feeding machine as in claim 1 wheras:
said food tray being subdivided into a plurality of compartments by partitions.

3. An automated pet feeding machine as in claim 1 wheras:
said fins positioned one against the housing and in line with the side of said food tray while a second fin is in line with the partition which separates the first compartment from the second compartment.

4. An automated pet feeding machine as in claim 1 wheras:
additional hopper modules provided to increase the capacity for food storage.

5. An automated pet feeding machine as in claim 1 wheras:
said bowl is releasably attached to the rest of the pet feeding machine.

6. An automated pet feeding machine as in claim 1 wheras:
said pet feeding machine is mechanically fastened on to a wall.

7. An automated pet feeding machine comprising:
a housing, a removable lid assembly, a hopper, a chute a food tray and a bowl;
a solenoid to tilt said food tray around a rotational axis from a first position into a second position and back;
a chute blocker to stop food from escaping said hopper while said food tray is in its second position;
a plurality of slidable vanes to regulate entry of food;
a main blocker slidably adjustable according to the size of the food;
two fins extending perpendicularly from said chute blocker, positioned and configured so as to eliminate possible jamming of food;
said food tray being subdivided into a plurality of compartments by partitions;
said fins positioned one against the housing and in line with the side of said food tray while a second fin is in line with the partition which separates the first compartment from the second compartment;
additional hopper modules provided to increase the capacity for food storage;
said bowl releasably attached to the rest of the pet feeding machine;
said pet feeding machine mechanically fastened on to a wall.
